(19) United States
(12) Patent Application Publication
(10) Pub. No.: US 2012/0194149 A1
(43) Pub. Date: Aug. 2, 2012

(54) POWER SUPPLY CIRCUIT, CONTROL METHOD FOR CONTROLLING POWER SUPPLY CIRCUIT, AND ELECTRONIC DEVICE INCORPORATING POWER SUPPLY CIRCUIT

(75) Inventor: Ippei NODA, Osaka (JP)

(73) Assignee: RICOH COMPANY, LTD., Tokyo (JP)

(21) Appl. No.: 13/345,862

(22) Filed: Jan. 9, 2012

(30) Foreign Application Priority Data
Feb. 1, 2011 (JP) 2011-019607

(51) Int. Cl. G05F 1/10

(52) U.S. Cl. 323/274; 323/284

(57) ABSTRACT

A power supply circuit electrically connectable to a load, including a reference voltage circuit, having a ground voltage detection element to detect a ground terminal voltage at the ground terminal of the load, to generate a reference voltage based on the detected ground terminal voltage; an error amplifier to generate a difference voltage between and the reference voltage and a load voltage detection circuit generated based on a voltage at a power supply terminal of the load; and a control circuit to control an output voltage of the power supply circuit such that the output voltage is set to a constant voltage based on the difference voltage from the error amplifier to cause a voltage between the power supply terminal and the ground terminal of the load to set to a predetermined voltage.

### CROSS-REFERENCE TO RELATED APPLICATIONS

This patent application is based on and claims priority pursuant to 35 U.S.C. §119 to Japanese Patent Application No. 2011-019607, filed on Feb. 1, 2011 in the Japan Patent Office, the entire disclosure of which is hereby incorporated by reference herein.

### BACKGROUND

1. Technical Field

This disclosure relates to a power supply circuit, a control method for controlling the power supply circuit, and an electronic device employing the power supply circuit; more particularly, a power supply circuit to supply highly accurate voltage to a load such as CPU.

2. Description of the Background Art

At present, reduced power consumption for electronic devices is required out of concern for the environment. In addition, portable devices contain various applications and thus require power supply circuits capable of corresponding to high-current output and low-voltage output. Further, the operating voltage range (guaranteed operation range) of load circuits such as a central processing unit (CPU) that is connected to an output of the power supply circuit gets narrower as the electronic devices become more compact. Therefore, power supply circuits whose fluctuation in output voltage is less than ever are required.

FIG. 1 is a circuit diagram illustrating a configuration of a conventional power supply circuit 4. In FIG. 1, the power supply circuit 4 includes dividing resistors R1 and R2 that divide a reference source voltage VREF from a reference voltage source 41 at a predetermined dividing ratio for output as a reference voltage Vr, dividing resistors R3 and R4 that divide an output voltage VOUT at a predetermine dividing ratio for output as a load detection voltage Vf, an error amplifier OP1 to detect an error voltage Ve between the voltages Vr and Vf, a switching transistor SW1, and a current source Ir1. An output terminal T1 of the power supply circuit 4 is connected to a load circuit 10 such as a CPU. The power supply circuit 4 controls the output voltage VOUT such that the output voltage VOUT is set to a predetermined voltage. Accordingly, a parasitic voltage drop (IR drop) occurs caused by a parasitic resistor Rp between the output terminal T1 of the power supply circuit 4 and a power supply terminal of the load circuit 10, or a parasitic resistor Rm between a ground terminal of the load circuit 10 and a ground voltage. Then, a voltage between both ends Vcup of the load circuit 10 (voltage across the load circuit) is represented by following formula 1.

Vcpu=Vout−(Icpu×Rp)−Icpu×Rm (1)

Herein, voltage error of the load circuit 10 is represented by the second and third terms on the right side of the formula 1. As a current Icpu of the load circuit 10 is increased, the effect of the voltage (voltage error in the load circuit) is increased, thereby heightening the risk of a malfunction.

In order to minimize the effect of the parasitic voltage drop and improve accuracy of the voltage, JP-2010-220454-A proposes an approach in which the voltage error in a load circuit can be minimized by using remote sensing. More specifically, in order to sense a voltage at a power supply terminal of the load and a voltage at a ground voltage thereof, a pair of sensing lines is connected to the vicinity of the load, and an output detection circuit to connect the sensing lines is provided in a DC-DC converter (power supply circuit).

However, in this configuration, since an error amplifier constituted by a differential amplifier in the output detection circuit is connected in series to a negative feedback circuit of the DC-DC converter, frequency characteristics of the negative feedback may deteriorate. In addition, in this configuration the error amplifier in the output detection circuit is provided in addition to an error amplifier to amplify a difference voltage in the DC-DC converter, which causes an increase in consumption of current and chip size of the circuit. Thus, this approach is unsuitable for the power supply circuit of portable electronic devices.

### BRIEF SUMMARY

In one aspect of this disclosure, there is a provided a power supply circuit electrically connectable to a load having a power supply terminal and a ground terminal. The power supply circuit includes a reference voltage circuit, an error amplifier, and a control circuit. The reference voltage circuit has a ground voltage detection element to detect a voltage at the ground terminal of the load as a ground terminal voltage and generates a predetermined reference voltage for output based on the detected ground terminal voltage. The error amplifier generates a difference voltage between the reference voltage from the reference voltage circuit and a load detection voltage generated based on a voltage at the power supply terminal of the load. The control circuit controls an output voltage of the power supply circuit such that the output voltage is set to a constant voltage based on the difference voltage generated from the error amplifier to set a voltage between the power supply terminal and the ground terminal of the load to a predetermined voltage.

In another aspect of this disclosure, there is a provided a control method for controlling the power supply circuit electrically connectable to a load having a power supply terminal and a ground terminal. The control method includes detecting a voltage at the ground terminal of the load; generating a reference voltage based on the detected voltage at the ground terminal of the load for output; generating a load detection voltage corresponding to a voltage at the power supply terminal of the load for output such that the load detection voltage is increased as a voltage at the power supply terminal of the load is increased and is decreased as the voltage at the power supply terminal of the load is decreased; generating a difference voltage between the load detection voltage and the reference voltage; and controlling an output voltage of the power supply circuit based on the generated difference voltage such that the output voltage is kept constant to set a voltage between the power supply terminal and the ground terminal of the load to a predetermined voltage.

In yet another aspect of this disclosure, there is a provided an electronic device including a load having a power supply terminal and a ground terminal, and the above-described power supply circuit electrically connectable to the load to supply an output voltage to the load.

### BRIEF DESCRIPTION OF THE DRAWINGS

The aforementioned and other aspects, features, aspects and advantages will be better understood by reference to the following detailed description when considered in connection with the accompanying drawings, wherein:

FIG. 1 is a circuit diagram illustrating a configuration of a conventional power supply circuit;

FIG. 2 is a circuit diagram illustrating a configuration of a power supply circuit using a linear regulator according to a first embodiment of this disclosure;

FIG. 3 is a circuit diagram illustrating a configuration of a power supply circuit according to a variation of the first embodiment shown in FIG. 2;

FIG. 4 is a circuit diagram illustrating a configuration of a power supply circuit according to a second embodiment;

FIG. 5 is a circuit diagram illustrating a configuration of a power supply circuit according to a variation of the second embodiment shown in FIG. 4; and

FIG. 6 is a circuit diagram illustrating a configuration of a power supply circuit using a switching regulator according to a third embodiment.

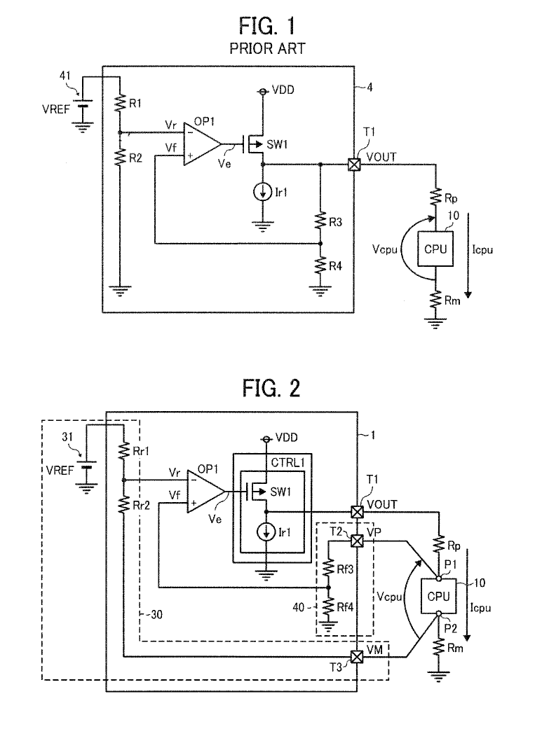

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views, particularly to FIGS. 2 through 6, power supply circuits according to illustrative embodiments are described.

### First Embodiment

FIG. 2 is a circuit diagram illustrating a power supply circuit 1 using a linear regulator according to a first embodiment. In FIG. 2, the power supply circuit 1 includes a reference voltage circuit 30, a load voltage detection circuit 40, an error amplifier OP1, and a control circuit CTRL1. The power supply circuit 1 is connected to a load circuit (e.g., central processing unit CPU) 10 having a power supply terminal P1 and a ground terminal P2.

The reference voltage circuit 30 includes a reference voltage source 31 to generate a reference source voltage VREF, dividing resistors Rr1 and Rr2, and a ground voltage detection terminal T3. It is to be noted, although the reference voltage source 31 is positioned outside of the power supply circuit 1 shown in FIGS. 2 through 6, the reference voltage source 31 may be provided inside the power supply circuit 1. In the reference voltage circuit 30, the dividing resistors Rr1 and Rr2 divide the reference source voltage VREF to generate a reference voltage Vr for output. Herein, the dividing resistors Rr1 and Rr2 function as a first resistor and a second resistor, respectively. The ground voltage detection terminal T3 is connected to the ground terminal P2 of the load circuit (load) 10 to detect a ground terminal voltage VM.

The load voltage detection circuit 40 includes a load voltage detection terminal T2 connected to the power supply terminal P1 of the load circuit 10 to detect a load voltage VP and dividing resistors Rf3 and Rf4. In the load voltage detection circuit 40, the dividing resistors Rf3 and Rf4 divide the load voltage VP to generate a load detection voltage Vf for output. Herein, the dividing resistors Rf3 and Rf4 function as a third resistor and a fourth resistor, respectively.

The error amplifier OP1 is constituted by a differential amplifier. The reference voltage Vr is applied to an inverting input terminal (−) of the error amplifier OP1, and the load detection voltage Vf is applied to a non-inverting input terminal (+) thereof. The error amplifier OP1 detects (generates) a difference between the reference voltage Vr and the load detection voltage Vf for output as an error voltage (difference voltage) Ve.

The control circuit CTRL1 includes a switching transistor SW1, and a current source Ir1 that is connected in series to the switching transistor SW1. The control circuit CTRL1 is connected to an output terminal T1 of the power supply circuit 1 and controls an output voltage VOUT at the output terminal T1 so that the output voltage VOUT is kept constant.

More specifically, in the reference voltage circuit 30, the dividing resistors Rr1 and Rr2 divide the reference source voltage VREF based on the ground terminal voltage VM at the ground terminal P2 of the load circuit 10 detected by the ground voltage detection terminal T3 to generate the reference voltage Vr. When the reference source voltage VREF is kept constant, the reference voltage circuit 30 adjusts the reference voltage Vr based on the ground terminal voltage VM so that the reference voltage Vr is kept constant.

In the load voltage detection circuit 40, the resistors Rf3 and Rf4 divide the load voltage VP to generate the load detection voltage Vf that is proportional to the load voltage VP for output. However, regarding the load detection voltage Vf, the present disclosure is not limited to the configuration described above, and thus, alternatively, the load voltage detection circuit 40 may generate a load detection voltage Vf that corresponds to the load voltage VP, where for example, the load detection voltage Vf has non-linear characteristics, that is, the load detection voltage Vf is increased as the load voltage VP is increased and the load detection voltage Vf is decreased as the load voltage VP is decreased.

In FIG. 2, representing a voltage between the both ends of the load circuit 10 (hereinafter “voltage across the load circuit 10”) as Vcpu, a parasitic resistance between the output terminal T1 and the power supply terminal P1 of the load circuit 10 as Rp, a parasitic resistance between the ground terminal P2 of the load circuit 10 and the ground voltage as Rm, and a current flowing through the load circuit 10 as Icpu, the voltages Vr and Vf input to the error amplifier OP1 can be calculated using following formulas 2 and 3, respectively.

$$\begin{matrix}Vr = \frac{Rr 2}{( R r 1 + R r 2 )} \times ( VREF - Icpu \times Rm ) + Icpu \times Rm & ( 2 ) \\ Vf = \frac{Rf 4}{( Rf 3 + Rf 4 )} \times VP & ( 3 )\end{matrix}$$

Since the power supply circuit 1 controls the voltages Vr and Vf such that the reference voltage Vr of the inverting input terminal (−) of the error amplifier OP1 is set equal to the load detection voltage Vf of the non-inverting terminal (+) thereof, following formula holds:

Vr=Vf (4)

Herein, the voltage Vcpu across the load circuit 10 is calculated using following formula 5.

Vcpu=VP−Icpu×Rm (5)

In addition, setting the resistances of the respective resistors Rr1, Rr2, Rf3, and Rf4 such that a relation “Rr1:Rr2=Rf4:Rf3” can be achieved, relation representing following formula 6 is obtained.

$$\frac{Rr 1}{( R r 1 + R r 2 )} = \frac{Rf 4}{( Rf 3 + Rf 4 )} = β 0 \qquad ( 6 )$$

Then, formula 7 can be obtained based on formulas 2 through 6.

$$Vcpu = \frac{( 1 - β 0 )}{β 0} \times VREF \qquad ( 7 )$$

In the formula 7, the power supply circuit 1 can set a parameter β0 and the reference source voltage VREF arbitrarily, and thus the right side of the formula 7 is not affected by the values for parameters Icpu, Rm and Rp. Accordingly, the voltage (load voltage) Vcpu across the load circuit 10 can get to a desirable voltage without being affected by the voltage error caused by parasitic voltage drop (IR drop shown in Rm, Rp). Moreover, the voltage at the ground terminal P2 of the load circuit 10 acts on the reference voltage circuit 30 via the ground voltage detection terminal T3, in addition to providing the load voltage detection terminal T2 and the resistors Rf3 and Rf4 in the load voltage detection circuit 40 similarly to the conventional configuration, which does not affect the negative feedback of the operational amplifier OP1 in the power supply circuit 1. Further, only the terminals T2 and T3 are added in the power supply circuit 1 in addition to the conventional power supply circuit 4, and therefore, there is no increase in either the consumption of current in the circuit or the chip size of the circuit.

As described above, in the present embodiment, the voltage error caused by the parasitic voltage drop can be minimized without increasing either the consumption of current or the chip size, which enables supply of a highly accurate and stable voltage to the load circuit 10 such as CPU.

### Variation of First Embodiment

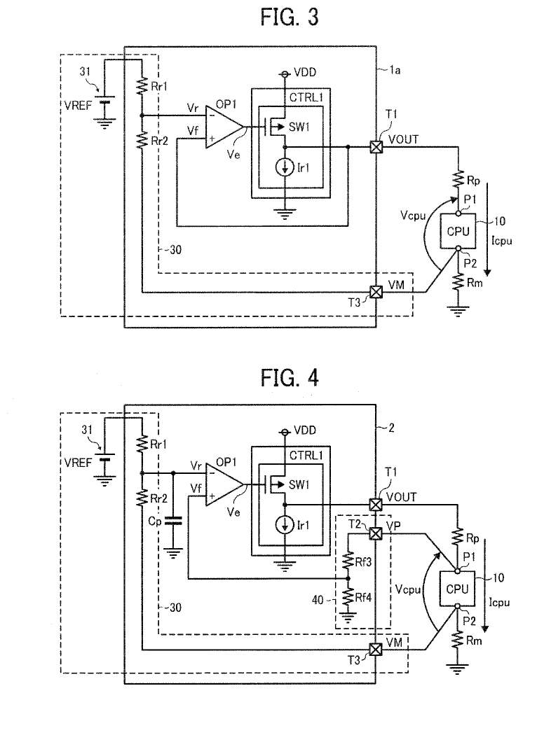

FIG. 3 is a circuit diagram illustrating a configuration of a power supply circuit 1a according to a variation of the first embodiment. In the power supply circuit 1a of the variation of the first embodiment, the load voltage detection terminal T2 and the resistors Rf3 and Rf4 are eliminated from the configuration of the power supply circuit 1 shown in FIG. 2, and the output voltage VOUT at the output terminal T1 of the power supply circuit 1a functions directly as the load detection voltage Vf. Thus, the parasitic resistor Rp is not taken into account but the parasitic resistor Rm is taken into account. Therefore, similar to the power supply circuit 1 shown in FIG. 2, in the power supply circuit 1a, the voltage error caused by the parasitic voltage drop can be minimized without increasing either the consumption of current or the chip size, enabling supply of a highly accurate and stable voltage to the load circuit 10 such as CPU.

### Second Embodiment

FIG. 4 is a circuit diagram illustrating a configuration of a power supply circuit 2 according to a second embodiment. A distinctive feature of the power supply circuit 2 is that a capacitor Cp is provided between a ground voltage and a junction node between the resistors Rr1 and Rr2, that is, an output terminal of the reference voltage circuit 30 to generate the reference voltage Vr. For example, even when the reference voltage Vr of the power supply circuit 1 fluctuates due to ground noise generated in the ground terminal P2 of the load circuit 10 such as a CPU or high-frequency noise mixed in the line between the load circuit 10 and the ground voltage detection terminal T3, the noise is superimposed on the output voltage VOUT of the output terminal T1 of the power supply circuit 1, which may generate an error in the voltage Vcpu across the load circuit 10. By connecting the capacitor Cp, the noised from the ground voltage detection terminal T3 is removed by a low pass filter constituted by the resistor Rr2 and the capacitor Cp, which can further minimize the error generated in the voltage Vcpu across the load circuit 10.

### Variation of Second Embodiment

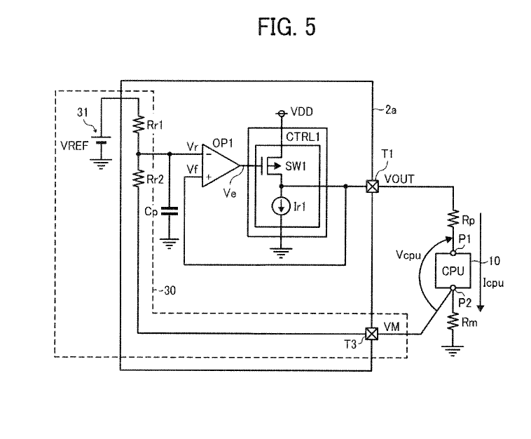

FIG. 5 is a circuit diagram illustrating a configuration of a power supply circuit 2a according to a variation of the second embodiment. Comparing to the power supply circuit 2 shown in FIG. 4, the load voltage detection terminal T2 and the resistors Rf3 and Rf4 are eliminated in the power supply circuit 2a, and the output voltage VOUT at the output terminal T1 of the power supply circuit 2a functions directly as the load detection voltage Vf. Thus, the parasitic resistor Rp is not taken into account, but the parasitic resistor Rm is taken into account. Therefore, similarly to the power supply circuit 2 shown in FIG. 4, in the power supply circuit 2a, the voltage error caused by the parasitic voltage drop can be minimized without increasing either the consumption of current or the chip size, enabling supply of a highly accurate and stable voltage to the load circuit 10 such as CPU.

### Third Embodiment

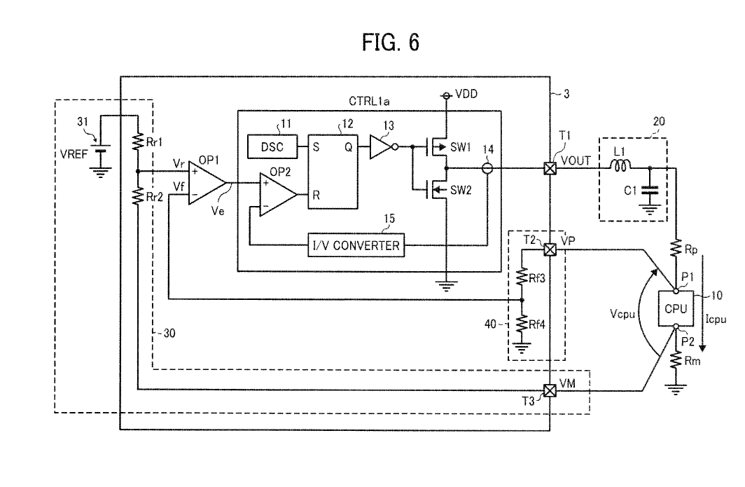

FIG. 6 is a circuit diagram illustrating a configuration of a power supply circuit 3 according to a third embodiment. A distinctive feature of the present embodiment is that the power supply circuit 3 is formed by a switching regulator instead of the linear regulator. A control circuit CTRL1a of the switching regulator 3 includes a clock generator 11, a SR-type flip-flop circuit 12, an inverter 13, a CMOS (Complementary Metal Oxide Semiconductor) circuit constituted by switching transistors SW1 and SW2, a current detector 14, a current-voltage converter (hereinafter “I/V converter”) 15, and an error amplifier OP2. In addition, a low-pass filer 20 to remove high-frequency and smooth the voltage, constituted by an inductor L1 and a capacitor C1, is provided between the output terminal T1 of the power supply circuit 3 and the parasitic resistor Rp.

Operation of the switching regulator 3 is described below. In the control circuit CTRL1a shown in FIG. 6, the error amplifier OP2 compares the error voltage Ve between the reference voltage Vr and the load detection voltage Vf with a voltage converted from a current flowing through the inverter L1 (I/V conversion) via the I/V converter 15 and outputs the compared output voltage to a reset terminal R of the flip-flop circuit 12. The flip-flop circuit 12 is set by a clock having constant frequency output from the clock generator 11, and one of the switching transistors SW1 and SW2 is complementarily turned on in a predetermined cycle in accordance with an output signal from the flip-flop circuit 12 via the inverter 13. When the load detection voltage Vf is lower than the reference voltage Vr, the ON time of the switching transistor SW1 becomes longer. Conversely, when the load detection voltage Vf is higher than the reference voltage Vr, the ON time of the switching transistor SW2 becomes longer. With this control, the reference voltage Vr is set to be equal to the load detection voltage Vf, and the voltage Vcpu across the load circuit 10 is set to a predetermined voltage.

In general, since a switching regulator repeats charging and discharging energy to the inductor and supplies a current to an output terminal, the switching regulator can convert a voltage at higher efficiency than can a linear regulator. Therefore, the switching regulator tends to be used for large-current, low-voltage output, and is extremely effective in minimizing the voltage error caused by the parasitic voltage drop.

As described above, in the present disclosure, the power supply circuit 3 formed by the switching regulator can minimize the voltage error caused by the parasitic voltage drop without increasing either the consumption of current or the chip size, enabling supply of a highly accurate and stable voltage to the load circuit 10 such as CPU.

It is to be noted that, similarly to FIGS. 4 and 5, the capacitor Cp can be provided in the power supply circuit 3 shown in FIG. 6.

Herein, although the preceding embodiments are described in terms of power supply circuits 1, 1a, 2, 2a, and 3, the present disclosure is not limited thereto and can be adapted as electronic devices employing respective power supply circuits 1, 1a, 2, 2a, and 3. In these configurations, the load circuit 10 is a circuit installed in the electronic device itself, and the electronic device includes various different devices, for example, mobile phones, mobile wireless terminals, equipment, and personal computers.

Numerous additional modifications and variations are possible in light of the above teachings. It is therefore to be understood that, within the scope of the appended claims, the disclosure of this patent specification may be practiced otherwise than as specifically described herein.

What is claimed is:

1. A power supply circuit electrically connectable to a load having a power supply terminal and a ground terminal,
the power supply circuit comprising:
a reference voltage circuit, having a ground voltage detection element to detect a voltage at the ground terminal of the load as a ground terminal voltage and generating a predetermined reference voltage for output based on the detected ground terminal voltage;
an error amplifier to generate a difference voltage between the reference voltage from the reference voltage circuit and a load detection voltage generated based on a voltage at the power supply terminal of the load; and
a control circuit to control an output voltage of the power supply circuit such that the output voltage is set to a constant voltage based on the difference voltage generated from the error amplifier to set a voltage between the power supply terminal and the ground terminal of the load to a predetermined voltage.

2. The power supply circuit according to claim 1, wherein the reference voltage circuit comprises a reference voltage source to generate a predetermined reference source voltage, and the reference voltage circuit adjusts the predetermined reference source voltage based on the detected ground terminal voltage to generate the reference voltage.

3. The power supply circuit according to claim 2, wherein the reference voltage circuit comprises a first resistor and a second resistor that divide the predetermined reference source voltage based on the detected ground terminal voltage to generate the reference voltage.

4. The power supply circuit according to claim 1, wherein the ground voltage detection element comprises a ground voltage detection terminal of the power supply circuit, and the ground voltage detection terminal is connected to the ground terminal of the load.

5. The power supply circuit according to claim 1, further comprises:
a load voltage detection circuit to generate a voltage for output as the load detection voltage corresponding to the voltage at the power supply terminal of the load such that the load detection voltage is increased as the voltage at the power supply terminal of the load is increased and is decreased as the voltage at the power supply terminal of the load is decreased.

6. The power supply circuit according to claim 5, wherein the load detection voltage is proportional to the voltage at the power supply terminal of the load.

7. The power supply circuit according to claim 6, wherein the load voltage detection circuit comprises a third resistor and a fourth resistor that divide the voltage at the power supply terminal of the load to generate the load detection voltage that is proportional to the voltage at the power supply terminal of the load for output.

8. The power supply circuit according to claim 7, wherein the reference voltage circuit comprises a first resistor and a second resistor that divide the predetermined reference source voltage based on the detected ground terminal voltage to generate the reference voltage, and
a resistance ratio of the third resistor and the fourth resistor in the load voltage detection circuit is equal to that of the first resistor and the second resistor in the reference voltage circuit.

9. The power supply circuit according to claim 7, wherein the load voltage detection circuit further comprises a load voltage detection terminal of the power supply circuit, and the load detection terminal is connected to the power supply terminal of the load.

10. The power supply circuit according to claim 1, wherein the load voltage detection voltage is an output voltage output by the power supply circuit.

11. The power supply circuit according to claim 1, further comprising a capacitor provided between an output terminal of the reference voltage circuit and a ground terminal of the power supply circuit.

12. The power supply circuit according to claim 1, wherein the power supply circuit comprises a linear regulator.

13. The power supply circuit according to claim 1, wherein the power supply circuit comprises a switching regulator.

14. A control method for controlling a power supply circuit electrically connectable to a load having a power supply terminal and a ground terminal,
the control method comprising:
detecting a voltage at the ground terminal of the load;
generating a reference voltage based on the detected voltage at the ground terminal of the load;
generating a load detection voltage corresponding to a voltage at the power supply terminal of the load for output such that the load detection voltage is increased as a voltage at the power supply terminal of the load is increased and is decreased as the voltage at the power supply terminal of the load is decreased;
generating a difference voltage between the load detection voltage and the reference voltage; and
controlling an output voltage of the power supply circuit based on the generated difference voltage such that the output voltage is kept constant to set a voltage between the power supply terminal and the ground terminal of the load to a predetermined voltage.

15. An electronic device comprising:
a load having a power supply terminal and a ground terminal,
a power supply circuit electrically connectable to the load to supply an output voltage to the load;
the power supply circuit comprising:
a reference voltage circuit having a ground voltage detection element to detect a voltage at the ground terminal of the load as a ground terminal voltage and generating a predetermined reference voltage for output as a reference voltage based on the detected ground terminal voltage;
an error amplifier to generate a difference voltage between the reference voltage from the reference voltage circuit and a load detection voltage generated based on a voltage at the power supply terminal of the load; and
a control circuit to control the output voltage of the power supply circuit such that the output voltage is set to a constant voltage based on the difference voltage from the error amplifier to set a voltage between the power supply terminal and the ground terminal of the load to a predetermined voltage.

16. The electronic device according to claim 15, wherein the power supply circuit further comprises a load voltage detection circuit to generate a voltage for output as the load detection voltage corresponding to the voltage at the power supply terminal of the load such that the load detection voltage is increased as the voltage at the power supply terminal of the load is increased and is decreased as the voltage at the power supply terminal of the load is decreased.

17. The electronic device according to claim 15, further comprising:
a reference voltage source to generate a predetermined reference source voltage,
wherein the reference voltage circuit adjusts a predetermined reference source voltage from the reference voltage source based on the detected ground terminal voltage to generate the reference voltage.

18. The electronic device according to claim 17, wherein the reference voltage source is positioned outside of the power supply circuit.
